(19) United States
(12) Patent Application Publication
(10) Pub. No.: US 2013/0294091 A1
(43) Pub. Date: Nov. 7, 2013

(54) LAMP HOLDER ASSEMBLY HAVING A REMOVABLE SHADE UNIT

(71) Applicant: Duan-Cheng Hsieh, Taipei City (TW)

(72) Inventor: Duan-Cheng Hsieh, Taipei City (TW)

(73) Assignee: HABITEX CORPORATION, Taipei City (TW)

(21) Appl. No.: 13/465,747

(22) Filed: May 7, 2012

(51) Int. Cl. F21V 11/00

(52) U.S. Cl. 362/361; 362/351

(57) ABSTRACT

A lamp holder assembly includes a holder and a light transmissive shade unit. The holder includes a plurality of connecting slots each having a wide slot section and a narrow slot section. The shade unit is provided with a plurality of connecting rods each having a rod body and a barb-like distal end. The rod bodies of the connecting rods extend respectively and movably through the narrow hole sections, and are movable into the wide slot sections, respectively. The barb-like distal end of each of the connecting rods is sized so as to allow movement through the wide slot section of a corresponding one of the connecting slots, while preventing movement through the narrow slot section of the corresponding one of the connecting slots.

### BACKGROUND OF THE INVENTION

1. Field of the Invention

This invention relates to a lamp, and more particularly to a lamp having a removable shade unit.

2. Description of the Related Art

Referring to FIG. 1, a conventional lamp holder assembly 1 includes a holder 11, a shade 12, and a plurality of screws 13, and is used for holding a light emitting member 100, such as an LED (light emitting diode) lamp, a tungsten lamp, and a halogen lamp.

The holder 11 is formed with a plurality of threaded holes 112. The shade 12 is formed with a plurality of through holes 121 aligned respectively with the threaded holes 112. The screws 13 extend through the through holes 121 to engage the threaded holes 112 for connecting the shade 12 removably to the holder 11. However, a tool (not shown) is required to drive the screws 13 when the aforesaid conventional lamp holder assembly 1 is assembled or disassembled, thereby resulting in inconvenience during use.

### SUMMARY OF THE INVENTION

The object of this invention is to provide a lamp holder assembly that has a removable shade unit and that is convenient to assemble and disassemble.

Accordingly, a lamp holder assembly of this invention includes a holder and a light transmissive shade unit. The holder includes a plurality of connecting slots each having a wide slot section and a narrow slot section. The shade unit is provided with a plurality of connecting rods each having a rod body and a barb-like distal end. The rod bodies of the connecting rods extend respectively and movably through the narrow hole sections, and are movable into the wide slot sections, respectively. The barb-like distal end of each of the connecting rods is sized so as to allow movement through the wide slot section of a corresponding one of the connecting slots, while preventing movement through the narrow slot section of the corresponding one of the connecting slots.

As such, by simply inserting the connecting rods into the wide slot sections of the connecting slots and subsequently rotating the shade unit relative to the holder in a direction to move the connecting rods into the narrow slot sections, the shade unit can be secured on the holder. Conversely, by simply rotating the shade unit relative to the holder in an opposite direction to move the connecting rods from the narrow slot sections into the wide slot sections, the shade unit can be removed from the holder. That is, no tool is required during assembly and disassembly of the lamp holder assembly.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a partly sectional side view of a conventional lamp having a removable shade;

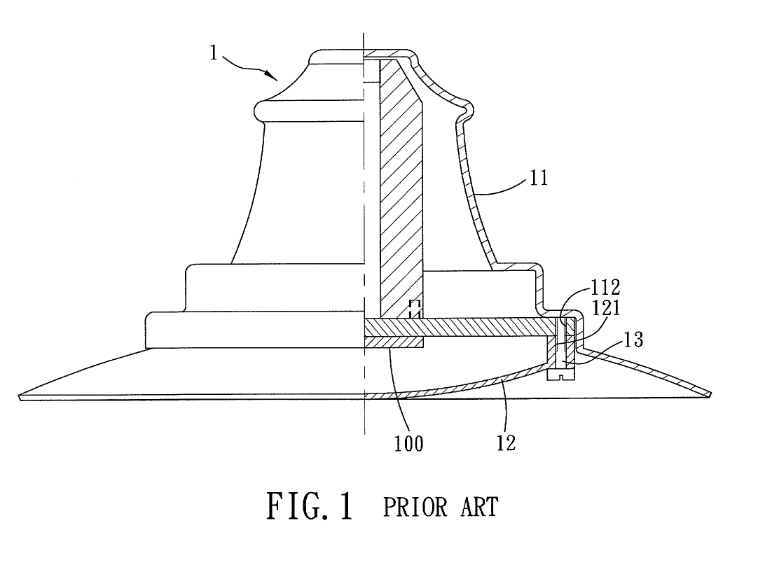

FIG. 2 is an exploded perspective view of the first preferred embodiment of a lamp holder assembly according to this invention;

FIG. 3 is a partly sectional side view of the first preferred embodiment;

FIG. 4 is a top view of a tray-shaped shade of the first preferred embodiment;

FIG. 5 is a partly sectional side view of the second preferred embodiment of a lamp holder assembly according to this invention, illustrating a modified connecting rod; and

FIG. 6 is a fragmentary perspective view of the third preferred embodiment of a lamp holder assembly according to this invention, illustrating a plurality of modified connecting slots.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

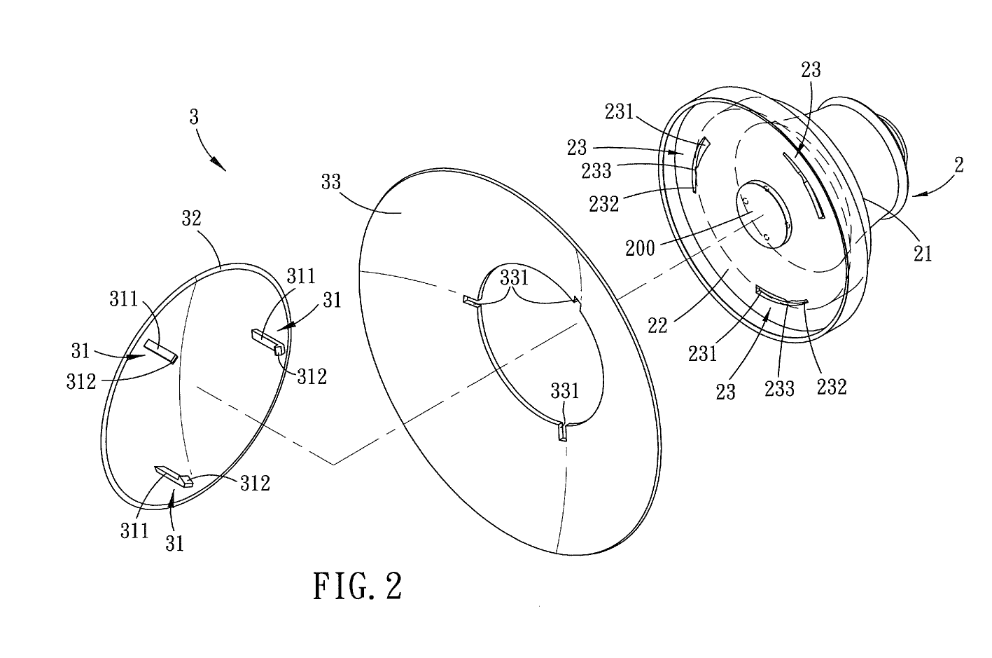

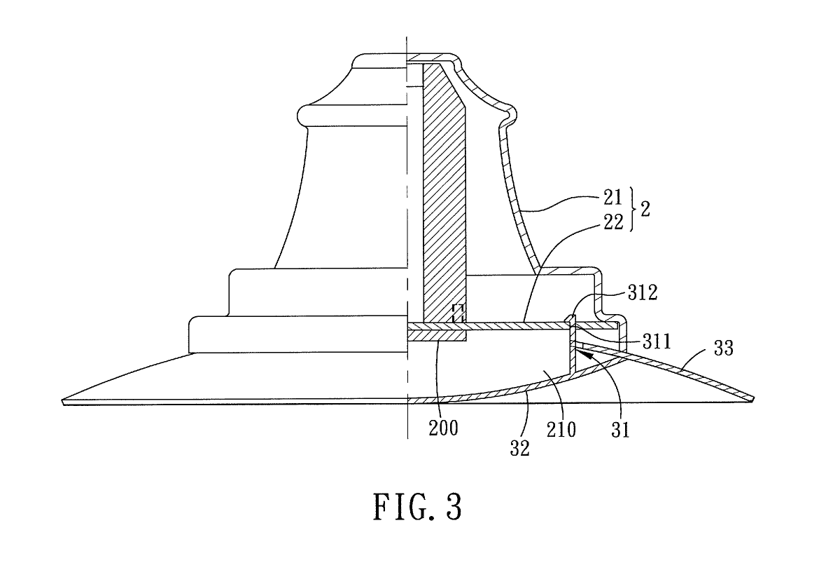

Referring to FIGS. 2 and 3, the first preferred embodiment of a lamp holder assembly according to this invention includes a holder 2 for holding a light emitting member 200, and a light transmissive shade unit 3 connected removably to the holder 2. The light emitting member 200 is hereby exemplified using an LED lamp, and may be a tungsten lamp or a halogen lamp.

The holder 2 includes a surrounding wall 21 and a disc 22 having a periphery connected fixedly to an inner surface of an intermediate portion of the surrounding wall 21 so as to define an accommodating space 210 for receiving the light emitting member 200. The disc 22 is formed with a plurality of connecting slots 23 arranged along a circumferential direction thereof. The number of the connecting slots 23 is but not limited to three.

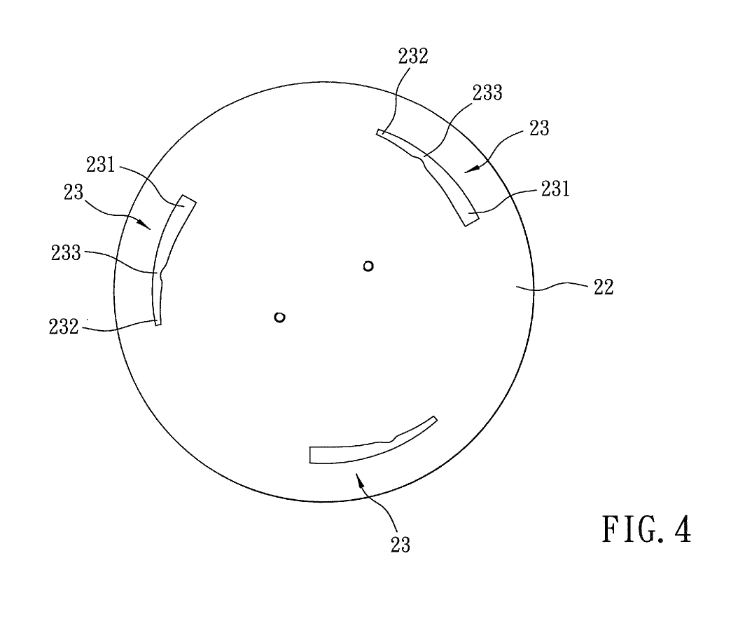

With further reference to FIG. 4, each of the connecting slots 23 has a wide slot section 231, a narrow slot section 232 narrower than the wide slot section 231, and a neck slot section 233 connected between and narrower than the wide and narrow slot sections 231, 232, such that the narrow slot section 232 extends from the neck slot section 233 in a counterclockwise direction.

The shade unit 3 includes a tray-shaped shade 32, a plurality of parallel connecting rods 31 extending from a side surface of the tray-shade shade 32, and an annular shade 33 disposed between the tray-shaped shade 32 and the holder 2.

The connecting rods 31 are aligned respectively with the connecting slots 23. Each of the connecting rods 31 has a rod body 311 extending movably through the narrow hole section 232 of the corresponding connecting slot 23, and a barb-like distal end 312 sized so as to allow movement through the wide slot section 231 of the corresponding connecting slot 23, while preventing movement through the narrow slot section 232 of the corresponding connecting slot 23.

The connecting rods 31 extend through the notches 331 in the annular shade 33 to connect the annular shade 33 removably between the tray-shaped shade 32 and the holder 2. The periphery of the tray-shaped shade 32 is but not limited to circular. The shape of the annular shade 33 may be designed according to needs of consumers, e.g., for preventing lateral leakage of light or different light transmitting effects.

The connecting rods 31 are but not limited to elongated straight plates. For example, the connecting rods 31 may have circular or square cross-section. If the shapes of connecting rods 31 are changed, those of the connecting slots 23 may need to change correspondingly. In this embodiment, the neck slot section 233 of each of the connecting slots 23 has a width slightly less than that of the rod body 311 of the corresponding connecting rod 31, such that the corresponding connecting rod 31 can be moved forcibly between the wide and narrow slot sections 231, 232 of the corresponding connecting slot 23 through the neck slot section 233 of the corresponding connecting slot 23.

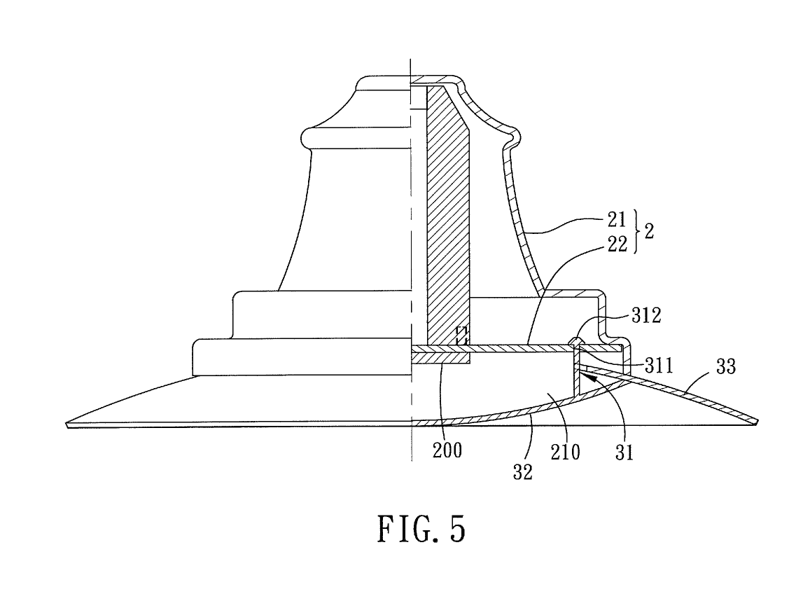

FIG. 5 shows the second preferred embodiment of a lamp holder assembly according to this invention, which is similar in construction to the first preferred embodiment except for modified connecting rods 31. The distal ends 312 of the modified connecting rods 31 are mushroom-shaped or generally T-shaped.

When it is desired to assemble the lamp holder assembly, the annular shade 33 is first connected to the tray-shaped shade 32 by engaging the rod bodies 311 of the connecting rods 31 with the notches 331 in the annular shade 33, respectively. Next, the connecting rods 31 are inserted respectively into the wide slot sections 231 of the connecting slots 23 in the holder 12 until the rod bodies 311 of the connecting rods 31 are disposed respectively within the same. Thereafter, the shade unit 3 is rotated relative to the holder 2 in a direction to move the connecting rods 31 from the wide slot sections 231 into the narrow slot sections 232, thereby completing the assembly of the holder 2 and the shade unit 3. Conversely, when it is desired to disassemble the lamp holder assembly, the shade unit 3 is rotated relative to the holder 2 in an opposite direction to move the connecting rods 31 from the narrow slot sections 232 into the wide slot sections 231, thereby allowing for removal of the shade unit 3 from the holder 2.

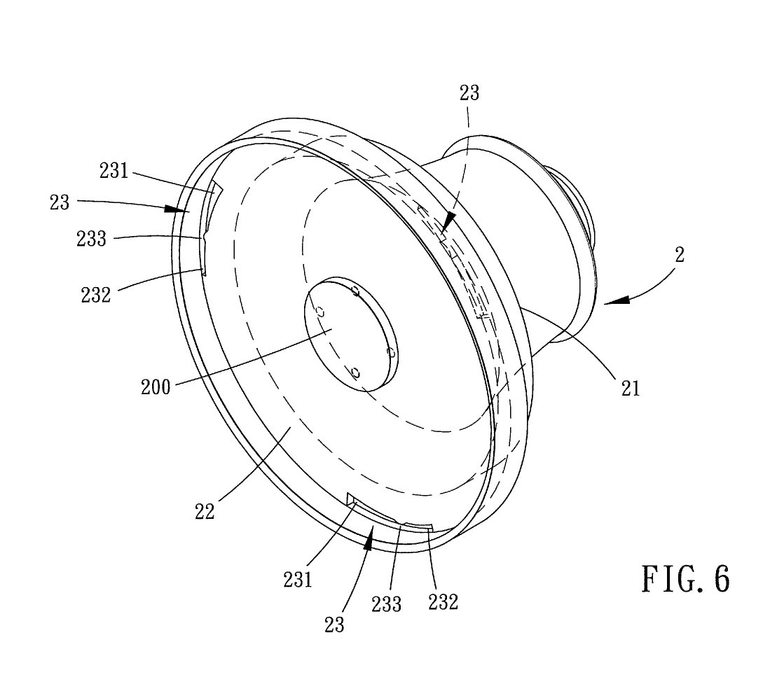

FIG. 6 shows the third preferred embodiment of a lamp holder assembly according to this invention, which is also similar in construction to the first preferred embodiment except for modified connecting slots 23. Each of the modified connecting slots 23 is defined between the periphery of the disc 22 and the inner surface of the surrounding wall 21.

In view of the above, the lamp holder assembly of this invention can be assembled and disassembled without any tool, thereby resulting in convenience during use. Thus, the object of this invention is achieved.

With this invention thus explained, it is apparent that numerous modifications and variations can be made without departing from the scope and spirit of this invention. It is therefore intended that this invention be limited only as indicated by the appended claims.

I claim:

1. A lamp holder assembly comprising:
a holder adapted for holding a light emitting member, said holder including a plurality of connecting slots each having a wide slot section and a narrow slot section that is narrower than said wide slot section; and
a light transmissive shade unit provided with a plurality of connecting rods each having a rod body and a barb-like distal end, said rod bodies of said connecting rods extending respectively and movably through said narrow hole sections of said connecting slots in said holder and being movable into said wide slot sections of said connecting slots, respectively, said barb-like distal end of each of said connecting rods being sized so as to allow movement through said wide slot section of a corresponding one of said connecting slots, while preventing movement through said narrow slot section of the corresponding one of said connecting slots.

2. The lamp holder assembly as claimed in claim 1, wherein each of said connecting slots further has a neck slot section connected between and narrower than said wide slot section and said narrow slot section of a corresponding of said connecting rods such that, said rod body of a corresponding one of said connecting rods can be moved forcibly between said wide and narrow slot sections of the corresponding one of said connecting slots through said neck slot section of the corresponding one of said connecting slots.

3. The lamp holder assembly as claimed in claim 1, wherein said holder further includes a disc formed with said connecting slots, and a surrounding wall having an inner surface connected fixedly to a periphery of said disc so as to define an accommodating space adapted for receiving the light emitting member.

4. The lamp holder assembly as claimed in claim 1, wherein said holder further includes a disc and a surrounding wall having an inner surface connected fixedly to a periphery of said disc so as to define an accommodating space adapted for receiving the light emitting member, each of said connecting slots being defined between the periphery of said disc and the inner surface of said surrounding wall.

5. The lamp holder assembly as claimed in claim 1, wherein said shade unit includes a tray-shaped shade provided with said connecting rods, and an annular shade connected removably between said holder and said tray-shaped shade.

6. The lamp holder assembly as claimed in claim 5, wherein said annular shade has an inner periphery formed with a plurality of notches, said connecting rods extending respectively through said notches.
